(19) United States
(12) Patent Application Publication
(10) Pub. No.: US 2007/0121046 A1
(43) Pub. Date: May 31, 2007

(54) Liquid crystal optical element, manufacturing method thereof, and vehicle light using same

(76) Inventor: Yasuo Toko, Tokyo (JP)

Correspondence Address: Masao Yoshimura;Chen Yoshimura, LLP, 6th Floor, 1101 Pennsylvania Ave., Washington, DC, 20004, US

(21) Appl. No.: 11/522,531

(22) Filed: Sep. 18, 2006

(30) Foreign Application Priority Data
Sep. 16, 2005 (JP) 2005-270535

(51) Int. Cl. G02F 1/1337

(52) U.S. Cl. 349/127

(57) ABSTRACT

A liquid crystal optical element including a pair of coupled substrates each having an electrode, and a liquid crystal layer between the substrates, the liquid crystal layer including an adjustable part and a non-adjustable part, the adjustable part containing liquid crystal having a dielectric anisotropy and being responsive to an electric field that is to be generated by applying a voltage between the electrodes so that orientations of liquid crystal molecules and a resulting refractive index distribution in the adjustable part change in accordance with the electric field, whereas orientations of liquid crystal molecules in the non-adjustable part is substantially fixed so that the non-adjustable part is substantially non-responsive to the electric field.

This application claims the benefit of Japanese Patent Application 2005-270535, filed in Japan on Sep. 16, 2005, which is hereby incorporated by reference in its entirety.

### BACKGROUND OF THE INVENTION

1. Technical Field of the Invention

The present invention relates to a liquid crystal optical element, to a manufacturing method thereof, and to a vehicle light using the same.

2. Description of the Related Art

In general, a vehicle light is configured to include a light source, a reflector, and a lens as the main components. The distribution of projection light in this type of vehicle light can be controlled by the methods described hereinbelow, for example.

As the first control method, a projection pattern formed on a lens surface provided in front of the light source is controlled through a lens cut. In this instance, the projection pattern is formed from direct light and reflected light. The direct light is emitted from the light source toward the front of the light source. The reflected light is emitted from the light source, directed toward the reflector behind the light source, reflected from a reflection surface of the reflector, and then is directed toward the front of the light source.

As the second control method, the direct light, which is emitted from the light source toward the front of the light source, is shielded. Therefore, a projection pattern is formed on the lens surface only from the reflected light which is emitted from the light source, directed toward the reflector, reflected from the reflection surface of the reflector, and then directed toward the front of the light source. The thus formed projection pattern is controlled only by means of the reflection surface of the reflector. In this case, the lens provided in front of the light source is typically a plain transparent lens which does not contribute to the light distribution control.

In addition to the light distribution control by means of the reflector or the lens as described above, a method for controlling light distribution have been proposed, which employs a liquid crystal panel. In this method, a liquid crystal panel is interposed between a light source and a lens provided in front of the light source, and the light emitted from the light source toward the lens is introduced into the liquid crystal panel. The transmittance of the liquid crystal panel is controlled in part to correspondingly control the transmitted amount of the light introduced into the liquid crystal panel, whereby the projection pattern formed on the surface of the lens through the liquid crystal panel is controlled. (See, for example, Japanese Patent Laid-Open Publications No. Hei 7-296605 and No. Hei 11-222073.)

In the above light distribution control method for a vehicle light employing the liquid crystal panel, the liquid crystal panel functions as a variable transmittance shutter or an optical mask. Therefore, the liquid crystal panel controls only the amount of the light guided in the liquid crystal panel but is not involved in the control of the optical path thereof. As a result, the light distribution can be controlled within a limited range of a basic light distribution of the vehicle light formed basically from a light source, a reflector, and a lens.

A polymer-dispersed liquid crystal is often employed as the liquid crystal employed in such an application. The general characteristics of the polymer-dispersed liquid crystal are that it is transparent when a voltage is applied and is in a clouded and non-transparent state when a voltage is not applied. Therefore, if the application of a voltage to the liquid crystal panel is stopped for some reason while the light is operated, the transmittance of the liquid crystal panel is reduced due to the cloudiness of the liquid crystal. Consequently, the amount of light radiated from the vehicle light is reduced to cause deterioration in visibility, and thus a problem arises in the drivability of a vehicle.

### SUMMARY OF THE INVENTION

Accordingly, the present invention has been devised in view of the abovementioned problems. It is an object of the invention to provide an improved liquid crystal optical element. Another object of the present invention is to provide an improved vehicle light.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purposes of the present invention, as embodied and broadly described, according to one aspect of the present invention, there is provided a liquid crystal optical element including a pair of coupled substrates each having an electrode, and a liquid crystal layer between the substrates, the liquid crystal layer including an adjustable part and a non-adjustable part, the adjustable part containing liquid crystal having a dielectric anisotropy and being responsive to an electric field that is to be generated by applying a voltage between the electrodes so that orientations of liquid crystal molecules and a resulting refractive index distribution in the adjustable part change in accordance with the electric field, whereas orientations of liquid crystal molecules in the non-adjustable part is substantially fixed so that the non-adjustable part is substantially non-responsive to the electric field.

In another aspect, the present invention provides a vehicle light including a light source, a reflector located behind the light source, and a liquid crystal optical element disposed in an optical path of light which is emitted from the light source, the liquid crystal optical element including a pair of coupled substrates each having an electrode, and a liquid crystal layer between the substrates, the liquid crystal layer including an adjustable part and a non-adjustable part, the adjustable part containing liquid crystal having a dielectric anisotropy and being responsive to an electric field that is to be generated by applying a voltage between the electrodes so that orientations of liquid crystal molecules and a resulting refractive index distribution in the adjustable part change in accordance with the electric field, whereas orientations of liquid crystal molecules in the non-adjustable part is substantially fixed so that the non-adjustable part being substantially non-responsive to the electric field.

In another aspect, the present invention provides a method for manufacturing a liquid crystal optical element, including preparing a pair of substrates each having an electrode and an alignment film, injecting a mixed material of a liquid crystal material and a photocurable monomer between the pair of the substrates, and selectively irradiating the mixed material with ultraviolet rays through a photomask to form a pattern of a hardened region and a non-hardened region.

According to one aspect of the present invention, an improved vehicle light can be realized which employs the liquid crystal optical element and which has the following characteristics: When a proper voltage is applied to the liquid crystal optical element, a light distribution can be controlled over a wide range beyond the range of basic light distribution of the vehicle light formed from the light source, the reflector, and the lens. In this configuration, the basic light distribution is maintained even when voltage application to a liquid crystal panel is stopped, whereby the function as a vehicle light can be ensured even in an abnormal state.

It is to be understood that both the foregoing general description and the following detailed description are exemplary and explanatory, and are intended to provide further explanation of the invention as claimed

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a schematic view illustrating an exemplary embodiment of a liquid crystal optical element according the present invention, part of which is cut;

FIG. 2 is a schematic view illustrating the optical path of light guided inside a liquid crystal layer of a liquid crystal optical element according to an embodiment of the present invention;

FIG. 3 is a graph showing the diffusion degree of light in a liquid crystal optical element according to an embodiment of the present invention;

FIG. 4 is a similar graph showing the diffusion degree of light in the liquid crystal optical element according to an embodiment of the present invention;

FIG. 5 is a schematic view illustrating a measurement method for the spread state of light for liquid crystal optical elements according to embodiments of the present invention are mounted on an optical system;

FIG. 6 is a cross-sectional view illustrating a light on which a liquid crystal optical element according to an embodiment of the present invention is mounted; and

FIGS. 7A and 7B are projected images of the light distribution of a light on which a liquid crystal optical element according to an embodiment of the present invention is mounted.

### DETAILED DESCRIPTION OF PREFERRED EMBODIMENTS

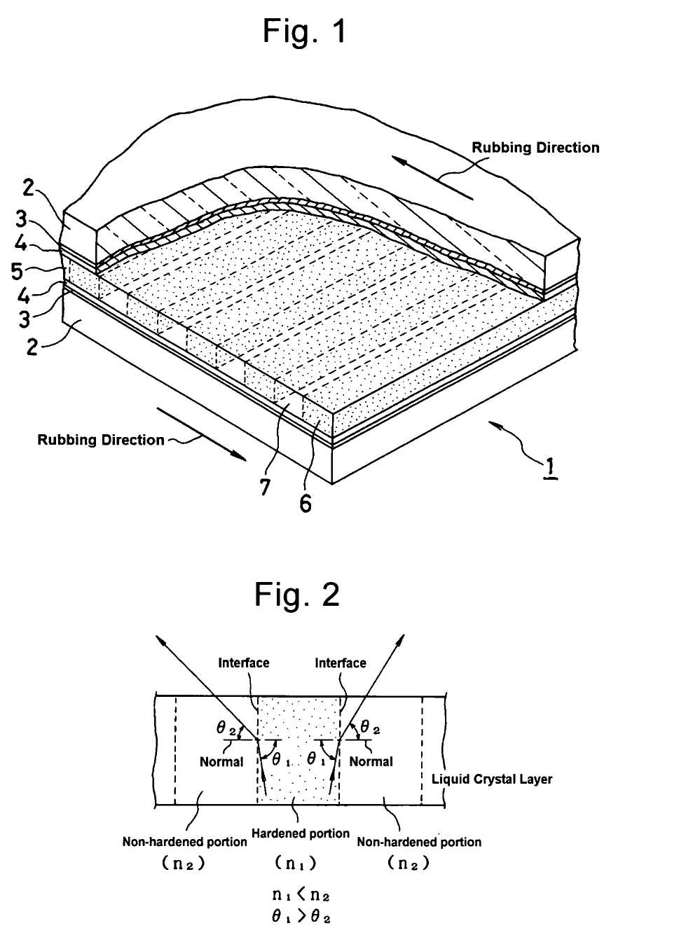

Hereinafter, preferred exemplary embodiments of the present invention will be described in detail with reference to FIGS. 1 to 7B (the same reference numerals refer to the same or similar parts). The exemplary embodiments described hereinafter are preferred specific examples of the present invention, and thus various technically preferable limitations are applied thereto. However, the scope of the present invention is not limited to the exemplary embodiments unless otherwise specifically stated in the following description that the invention is limited thereto.

FIG. 1 is a perspective view illustrating an exemplary embodiment of a liquid crystal optical element according the present invention. The basic configuration of the liquid crystal optical element 1 will be first described. The liquid crystal optical element 1 includes transparent substrates 2 which are made of a glass, a resin, or the like and are disposed opposite and approximately parallel to each other with a predetermined gap. Furthermore, a transparent electrode 3 composed of an ITO film or the like is formed on each of the opposing surfaces of the transparent substrates 2 by means of a vapor deposition method, an ion plating method, a sputtering method, or the like.

Furthermore, an alignment film 4 is formed on the surface of each of the transparent electrodes 3 in order to align liquid crystal molecules in a certain direction. The alignment film 4 is composed of an organic polymer film made of a polyimide-based resin or the like. A sealing material (not shown) is applied to the peripheral portion between the alignment films 4 opposed to each other with a predetermined gap, and a liquid crystal layer 5 is formed by filling a space with a liquid crystal material, the space being surrounded by the sealing material and the alignment films 4 opposed to each other.

Furthermore, the surface of each of the alignment films 4 may be subjected to an alignment treatment in order to uniformly distribute the liquid crystal molecules and to align the liquid crystal molecules in a predetermined alignment direction. The alignment treatment is achieved by, for example, rubbing the surface of the alignment films in the directions shown by arrows in FIG. 1 by use of natural fiber or synthetic fiber such as rayon to thereby form fine grooves.

In the alternative, the rubbing may be omitted. Specifically, a cell may be produced without rubbing but simply using the original surface state of the alignment films 4 (called as “no rubbing: NR”). In this case, the liquid crystal molecules can be aligned horizontally to the surface of the alignment films although the two-dimensional alignment directions of the liquid crystal molecules are relatively random. Since the liquid crystal molecules have characteristics that they are spontaneously aligned to each other, the alignment is not perfectly random, but the adjacent liquid crystal molecules are aligned approximately in parallel. In other words, the liquid crystal molecules form so-called amorphous alignment in which short-range order is present but the alignment directions of the liquid crystal molecules apart from each other are not uniform, i.e., long-range order is absent. If the alignment films have a surface state in which the surface energy thereof is about 40 dyn/cm or more, the liquid crystal molecules are aligned horizontally to the surface of the alignment films.

The gap (cell gap) between these substrates (including the alignment film) is preferably set within the range of about 4 to about 75 μm. In the case of antiparallel cells, within the above range for the cell gap, the diffusion characteristics of the liquid crystal layer 5 are optimal at 15 μm. In addition, for antiparallel cells, the response speed is optimal at 4 μm, and the diffusion characteristics are also favorable thereat.

Liquid crystal that has characteristics that the dielectric anisotropy Δ∈ is positive (Δ∈>0) may be used. In this case, when a potential difference is applied via the transparent electrodes, the liquid crystal molecules are aligned such that the long molecular axis thereof is parallel to the direction of the electric field.

For example, liquid crystal that has a refractive index anisotropy Δn of approximately 0.25 may be used. (In the embodiments showin in Table 1 below and thereafter, the refractive index for ordinary ray no is approximately 1.51, the refractive index for extraordinary ray nₑ is approximately 1.76, and the refractive index anisotropy Δn=nₑ−nₒ≈0.25.)

A photocurable monomer (a monomer exhibiting liquid crystallinity is employed in this exemplary embodiment) is added to the liquid crystal for the liquid crystal layer 5 in the range of 1 to 15 wt. %, and the monomer can be polymerized by irradiating a part of the liquid crystal layer 5 with ultraviolet rays.

No particular limitation is imposed on the photocurable monomer, so long as it is photocurable. In exemplary embodiments of the present invention, a UV curable liquid crystal UCL-001 (product of DAINIPPON INK AND CHEMICALS, INCORPORATED) was employed. Experiments were conducted by adding the UV curable liquid crystal UCL-001 to the liquid crystal in an amount of about 0.5 to about 20 wt. %. As described later, it was found that approximately the same results were obtained when the weight percent of the UV curable liquid crystal was added within the range of about 1 to about 15 wt. %.

In the preferred embodiments, when a monomer is polymerized by irradiating, with ultraviolet rays, the liquid crystal to which the photocurable monomer is added, a photomask is placed on the external surface of at least one of the glasses holding the liquid crystal layer therebetween. Then, ultraviolet rays are projected toward the liquid crystal layer from the outside of the photomask. Here, examples of preferable photomasks include, but not limited to, a glass mask in which alternating stripes of a transparent portion and a light shielding portion are formed on a glass substrate; and a metal mask in which alternating stripes of a penetrating portion and a non-penetrating portion are formed on a metal plate.

The photomask is composed of the stripes of the ultraviolet ray transparent portion and the stripes of the light shielding portion, and these portions may have the same width. The width of the stripes of the ultraviolet transparent portion and the ultraviolet ray shielding portion is preferably within the range of about 10 to about 100 μm, and more preferably within the range of about 20 to about 50 μm. In the embodiments of the present invention, the width of the ultraviolet ray transparent portion is 30 μm, and the width of the light shielding portion is also 30 μm. The irradiation time with ultraviolet rays is preferably within the range of about 10 to about 120 sec, and more preferably within the range of about 30 to about 120 sec. In this exemplary embodiment, an irradiation time of 60 sec is employed.

In this manner, the liquid crystalline monomer added to the liquid crystal is polymerized to form a polymer in a portion 6 (which will be referred to as “hardened portion” or “non-adjustable part” hereinafter for convenience) in the liquid crystal layer 5, and the liquid crystalline monomer is not polymerized in a portion 7 (which will be referred to as “non-hardened portion” or “adjustable part” hereinafter for convenience) therein. In this example, these portions are arranged in alternating stripes as shown in FIG. 1. The relationship between the stripes and the alignment treatment (if the alignment treatment is performed) is set such that the extending direction of the line portion of the stripes is approximately orthogonal to the rubbing directions. It should be appreciated that the rubbing directions are not limited to the direction approximately orthogonal to the extending direction of the line portion of the stripes. The rubbing may be performed in directions set within the range of about ±45° relative to the direction orthogonal to the extending direction of the line portion of the stripes, and more preferably within the range of about ±5°.

A description will next be given of an optical system of the liquid crystal optical element of FIG. 1. When a voltage is not applied to the liquid crystal optical element 1, an interface at which the refractive indices are largely different is absent between the non-hardened portion 7 and the hardened portion 6 that has been polymerized. This is due to the following reasons. The polymerized hardened portion 6 has a configuration in which the initial alignment of the liquid crystal is fixed. The refractive index distribution of the liquid crystalline monomer before the polymerization is approximately coincident with that of the liquid crystal. This refractive index distribution is maintained even after the polymerization. Hence, the transmitting light beam is hardly affected. Furthermore, even if the polymer contains the liquid crystal mixed therein during the polymerization, the optical influence thereof is very small since the refractive index distributions are approximately the same.

When a voltage is applied to the liquid crystal optical element 1, no change occurs in the hardened portion 6 since the configuration is fixed.

However, the liquid crystal constituting the non-hardened portion 7 (liquid crystal portion) changes its alignment direction according to the magnitude of the applied voltage. For a liquid crystal having a positive dielectric anisotropy, the alignment direction is changed such that the long molecular axis is aligned along the electric field. For a liquid crystal having a negative dielectric anisotropy, the alignment direction is changed such that the long molecular axis is orthogonal to the electric field. In the exemplary embodiments of the present invention, since the dielectric anisotropy is positive, the alignment direction of the liquid crystal is changed so as to align along the direction of the electric field. As a result, the refractive index distribution of the non-hardened portion deviates from the refractive index distribution of the hardened portion, and thus the interface due to the difference in refractive index is generated between the non-hardened portion and the hardened portion.

Therefore, in the liquid crystal optical element 1 having the abovementioned configuration, when a voltage is not applied, the light projected onto one of the surfaces of the liquid crystal optical element 1 behaves in the same manner as light transmitting a transparent member. Therefore, the light distribution of the light emitted from the other surface is almost unchanged.

As shown in FIG. 2, when a voltage is applied to the liquid crystal optical element 1, a part of the light projected onto one of the surfaces of the liquid crystal optical element 1 is directed to the interface between the hardened portion 6 and the non-hardened portion 7. Then, the light directed to the interface travels along an optical path having a refractive index difference at the interface. At this time, the light beam is refracted according to the refractive index change in the optical path. Since both the non-hardened portion 7 (which is a non-cured portion of the liquid crystal with the monomer) and the hardened portion 6 (which is a cured portion of the liquid crystal with the monomer) are optical mediums having a refractive index anisotropy, the difference in refractive index at the interface is different depending on the incident angle of the light beam. In addition to this, since fine projections and depressions are present on the surface of the hardened portion 6 due to polymerization by ultraviolet irradiation, variations are present in the emitting direction of the light beams incident on the interface. Therefore, while the light beams are scattered to some extent, the light beams as a whole travel along a particular direction for each interface.

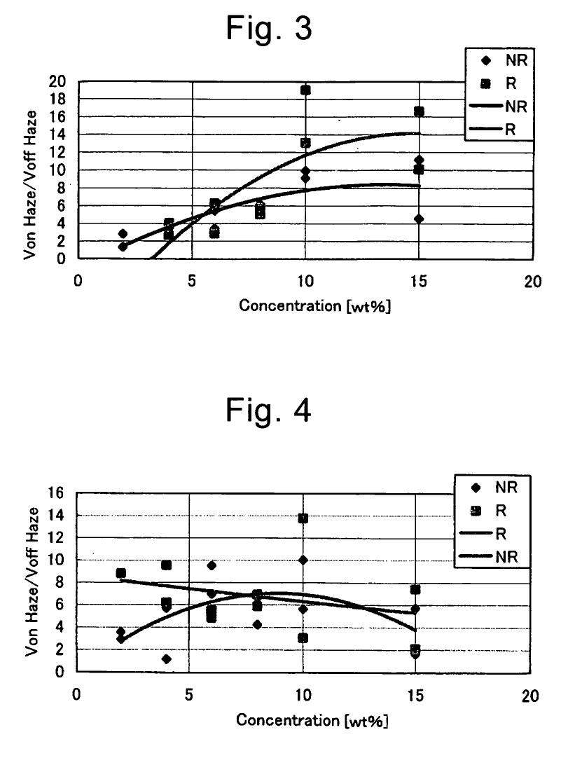

FIGS. 3 and 4 are graphs showing the ratio (VonHaze/VoffHaze: diffusion degree) of haze value (VonHaze) when a voltage is applied to the liquid crystal optical element with respect to haze value (VoffHaze) when a voltage is not applied. FIGS. 3 and 4 show the ratio (VonHazeNoffHaze) for each of a non-rubbing cell (NR) not subjected to the alignment treatment and an antiparallel cell (R) subjected to the alignment treatment. The ratio (VonHaze/VoffHaze) is plotted against the weight percent (wt. %) of the liquid crystalline monomer, which is added to the liquid crystal. FIG. 3 shows the measurement results for a liquid crystal optical element having a cell gap (the thickness of the liquid crystal layer) of 4 μm, and FIG. 4 shows the measurement results for a liquid crystal optical element having a cell gap of 15 μm.

The haze value is also referred to as “cloudiness value” and is the ratio of an amount of diffused transmission light to a total amount of transmission light when, for example, visible light is projected onto a film. Therefore, the larger the value is, the larger the ratio of the amount of the diffused transmission light with respect to the total amount of the transmission light is. Accordingly, the ratio (VonHaze/VoffHaze) shown in FIGS. 3 and 4 represents that the larger the value is, the larger the ratio of the amount of the diffused transmission light when a voltage is applied with respect to that when a voltage is not applied is (diffusion degree).

As can be seen from FIG. 3, when the amount of monomer added to the liquid crystal is 15 wt. % or less, the diffusion degree increases as the amount of the monomer increases for both the non-rubbing cell (NR) not subjected to the alignment treatment and the antiparallel cell (R) subjected to the alignment treatment. As is also clear from the figure, when the added amount of the monomer is approximately 6 wt. % or more, the diffusion degree in the antiparallel cell (R) is larger than that in the non-rubbing cell (NR).

As can be seen from FIG. 4, when the amount of monomer added to the liquid crystal is 15 wt. % or less, the diffusion degree of the non-rubbing cell (NR) exhibits a maximum value at approximately 10 wt. %. On the other hand, the diffusion degree of the antiparallel cell (R) decreases as the weight percent of the monomer increases.

A comparison of the absolute value of the diffusion degree was made between the liquid crystal optical element having a cell gap of 4 μm and that having a cell gap of 15 μm. The comparison reveals that large degrees of diffusion degree are obtained at approximately 6 wt. % or more in the antiparallel cell (R) that has a cell gap of 4 μm and that was subjected to the alignment treatment.

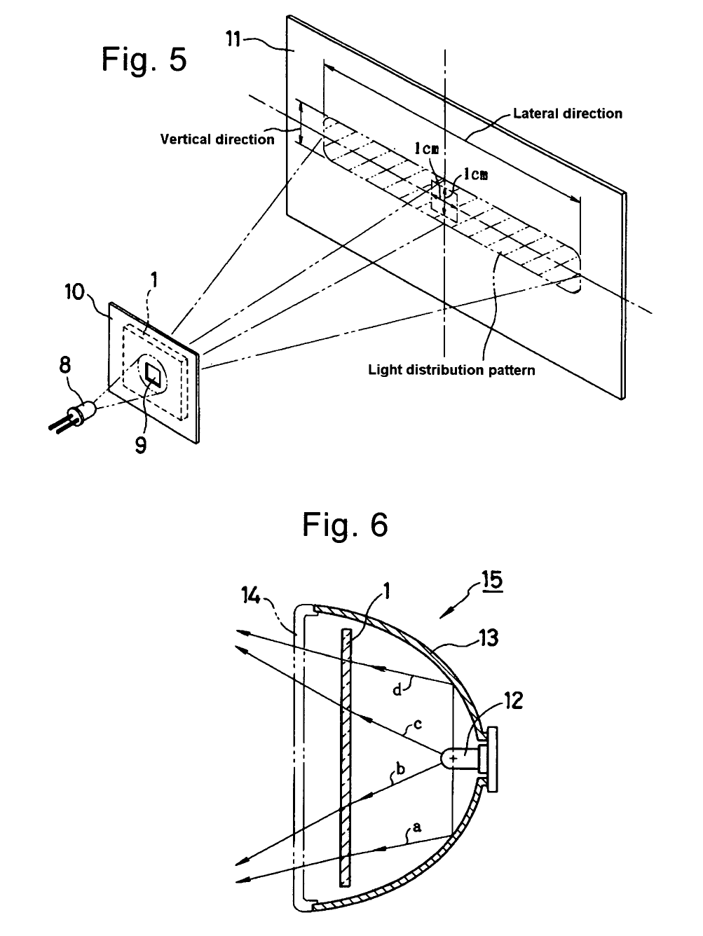

Table 1 shown below is a data sheet including the measurement results for a spread state of the light transmitted through the liquid crystal optical element. The measurements were performed by mounting a prototype liquid crystal optical element on a practical optical system. In the measurement method, an LED was employed as a light source as shown in FIG. 5 since the liquid crystal optical element may be used with an LED light source. Furthermore, a light shielding plate 10 provided with a square light transmission window 9, the liquid crystal optical element 1, and a screen 11 were sequentially placed in front of an LED 8 serving as the light source. In this experiment, the orientation of the liquid crystal element 1 was such that the extending direction of the alternating stripes in the liquid crystal cell aligns with the vertical direction.

The measurement procedure is as follows. First, the LED 8 was turned on while a voltage was not applied to the liquid crystal optical element 1. The distance between the LED 8 and the liquid crystal optical element 1 and the distance between the liquid crystal optical element 1 and the screen 11 were adjusted relative to each other, and each of these distances was set such that a projection pattern of 1 cm square was projected onto the screen 11.

Next, a predetermined voltage was applied to the liquid crystal optical element 1, and the projection pattern projected onto the screen 11 was measured for the vertical and lateral sizes and the shape.

For each of the non-rubbing cell (NR) not subjected to the alignment treatment and the antiparallel cell (R) subjected to the alignment treatment, three measurement sample cells having cell gaps 4 μm, 15 μm, and 75 μm, respectively, were prepared. For each of these cells, two liquid crystal optical elements into which the liquid crystal was injected were prepared with each of various amounts of the liquid crystalline monomer added to the liquid crystal (2%, 4%, 6%, 8%, 10%, 15%, and 20%, respectively).

TABLE 1

| Cell | | | Weight Percentage of the monomer in LC layer (wt. %) | | | | | | | |
|---|---|---|---|---|---|---|---|---|---|---|
| gap | Rubbing | Sample | 2 | | 4 | | 6 | | 8 | |
| [μm] | (R/NR) | (No.) | L | V | L | V | L | V | L | V |
| 4 | NR | 1 | (8.0) | (5.0) | 8.7 | 1.2 | (10.0) | (4.0) | (9.0) | (9.0) |
| | | 2 | (8.5) | (5.0) | 8.6 | 1.2 | (9.5) | (4.0) | (10.5) | (10.5) |
| | R | 1 | — | — | 9.0 | 1.5 | 9.0 | 2.0 | 9.2 | 1.2 |
| | | 2 | — | — | 9.0 | 1.5 | 9.0 | 2.0 | 9.0 | 1.3 |
| 15 | NR | 1 | 10.0 | 2.5 | (8.0) | (5.0) | (10.0) | (5.0) | 10.0 | 5.0 |
| | | 2 | 10.0 | 3.0 | (8.2) | (5.0) | (10.0) | (4.5) | 9.5 | 5.0 |
| | R | 1 | 9.5 | 1.0 | 10.0 | 1.5 | 10.2 | 2.0 | 10.0 | 2.0 |
| | | 2 | 10.0 | 1.0 | 10.0 | 2.0 | 9.5 | 1.5 | 10.0 | 1.5 |
| 75 | NR | 1 | 9.0 | 3.0 | (10.0) | (10.0) | — | — | — | — |
| | | 2 | 10.0 | 3.0 | (9.5) | (9.5) | — | — | — | — |

| | | | Weight Percentage of the monomer in LC | | |
|---|---|---|---|---|---|
| Cell | | | layer (wt. %) | | |
| gap | Rubbing | Sample | 10 | 15 | 20 |

| [μm] | (R/NR) | (No.) | L | V | L | V | L | V |
|---|---|---|---|---|---|---|---|---|
| 4 | NR | 1 | 9.0 | 3.0 | 9.0 | 3.2 | 8.0 | 4.5 |
| | | 2 | 8.5 | 3.5 | 9.0 | 3.0 | 8.3 | 4.5 |
| | R | 1 | 8.5 | 1.3 | 9.5 | 1.5 | — | — |
| | | 2 | 9.0 | 1.3 | 9.5 | 2.0 | — | — |
| 15 | NR | 1 | 9.7 | 4.0 | (9.5) | (4.0) | — | — |
| | | 2 | 10.0 | 3.6 | (10.0) | (4.5) | — | — |
| | R | 1 | 10.0 | 1.5 | 9.5 | 2.0 | — | — |
| | | 2 | 10.0 | 1.5 | 9.5 | 2.5 | — | — |
| 75 | NR | 1 | — | — | — | — | — | — |
| | | 2 | — | — | — | — | — | — |

Note:
V: Vertical direction
L: Lateral direction
R: Antiparallel cell
NR: Non-rubbing cell
With parenthesis: Projected light is circular or ellipsoidal
Mark “—”: Not measured

As can be seen from Table 1, in the non-rubbing cell (NR) not subjected to the alignment treatment, the optical anisotropy is small, and the light is scattered also in the vertical direction. Particularly, for the liquid crystal optical elements for which the results are shown in parentheses in the data sheet, the shape of the projection pattern of the projection light was deformed and was circular or ellipsoidal. Furthermore, a comparison was made among the antiparallel cells (R) subjected to the alignment treatment. The comparison shows that the spreading amount of the projection pattern of the projection light in the lateral direction was approximately 10 cm for the liquid crystal cells having a cell gap of 15 μm and was approximately 9 cm for the liquid crystal cells having a cell gap of 4 μm. Furthermore, for each of the cases, the spreading amount of the projection pattern of the projection light in the vertical direction was in the order of one to two times as large as the initial spreading amount, or 1 cm, (the spreading amount when a voltage was not applied to the liquid crystal layer). In particular, in the liquid crystal optical element having a cell gap of 15 μm and containing the monomer in an amount of 2 wt. %, the diffusion degree in the vertical direction was small, and thus the characteristics were excellent in that regard. Note that, for the antiparallel cells (R) subjected to the alignment treatment, the dependency of the optical anisotropy on the weight percentage of the photocurable monomer was generally not large.

The response speed of the liquid crystal optical element having a cell gap of 15 μm was about 90 ms, and the response speed of the liquid crystal optical element having a cell gap of 4 μm was about 30 ms. Furthermore, when the photocurable monomer in an amount of 20 wt. % or more was added to the liquid crystal and was cured, the liquid crystal composition was entirely solidified except the NR 4 μm samples, and thus the alignment of liquid crystal molecules was not changed even when a voltage was applied.

The liquid crystal optical element having the above characteristics can be employed in a system, for example, shown in FIG. 6. Specifically, in a light 15 having a light source 12, a reflector 13 placed around the light source 12, and a lens 14 placed in front of the light source 12, the liquid crystal optical element 1 is placed between the light source 12 and the lens 14.

In this case, when a voltage is not applied to the liquid crystal optical element 1, the light from the light source 12 transmits through the liquid crystal optical element 1 without being changed and reaches the surface of the lens 14. Therefore, a desired light distribution is obtained through the lens cut of the lens 14. On the other hand, when a voltage is applied to the liquid crystal optical element 1, parts (a to d) of the light emitted from the light source 12 and reaching the liquid crystal optical element 1 are refracted by the liquid crystal optical element 1 in various directions in accordance with the pattern and orientation of the liquid crystal optical element 1. Thus, the light containing the refracted scattering light forms a projection pattern spread into a certain shape and reaches the surface of the lens 14. Then, a light distribution is further spread through the lens cut of the lens 14 when the lens 14 has such a cut.

Specifically, when a voltage is not applied to the liquid crystal optical element 1, the light 15 having the liquid crystal optical element 1 mounted thereon forms a basic distribution pattern formed from the light source 12, the reflector 13, and the lens 14 as in a conventional light. When a voltage is applied to the liquid crystal optical element 1, the light 15 forms a light distribution pattern formed through a combination of the optical anisotropy of the liquid crystal optical element 1 and the light distribution characteristics of a conventional light.

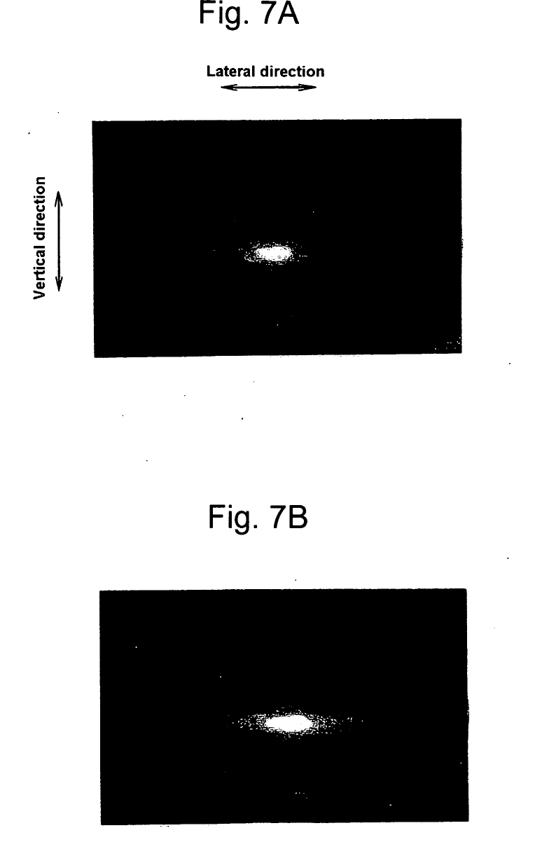

FIGS. 7A and 7B show projected images of the light distribution of a vehicle light having a liquid crystal optical element according to an embodiment of the present invention. FIG. 7A shows a light distribution pattern of the vehicle light when a voltage is not applied to the liquid crystal optical element, and FIG. 7B shows a light distribution pattern of the vehicle light when a voltage is applied to the liquid crystal optical element. In this example, the extending direction of the alternating stripes of the light crystal optical element 1 was aligned with the vertical direction so that the light spreading effect primarily occurs in the horizontal direction.

As shown in these figures, the light distribution pattern when the liquid crystal optical element was operated was clearly spread to a greater extent in the horizontal direction as compared to the light distribution pattern when the liquid crystal optical element was not operated. Furthermore, almost no light distribution pattern spreading was found in the vertical direction irrespective of whether the liquid crystal optical element was operated or not operated. This means that the optical anisotropy of the liquid crystal optical element functions effectively. In addition, this shows that the liquid crystal optical element has optical characteristics which can meet the light distribution characteristics requirements for a vehicle headlight, for example.

In the light depicted in FIG. 6, direct light from the light source 12 contributes to the forward emission. However, the liquid crystal element of the present invention can be used in other types of light structure, such as those in which most of light emitted from the light source is reflected by a front reflector and is reflected by a back reflector towards the exterior through a clear front lens.

As described above, in the liquid crystal optical element according to one aspect of the present invention, the photocurable liquid crystalline monomer is added to the liquid crystal to form the liquid crystal material, and this liquid crystal material is injected into the cell. The liquid crystal molecules and liquid crystalline monomer thus injected may be uniformly aligned by alignment films that are appropriately processed in advance. Then, portions of the liquid crystal cell in this state are irradiated with ultraviolet rays to form the stripe-like hardened portions in which the monomer is polymerized, whereby the stripe-like hardened portions and the stripe-like non-hardened portion are arranged adjacent to one another to serve as a grating part. In this instance, when a voltage is not applied, since the orientation of liquid crystal is the same as before the ultraviolet irradiation, the liquid crystal optical element is transparent. When a voltage is applied, light is scattered in a predetermined direction by virtue of the difference in refractive index between the hardened portions irradiated with the ultraviolet rays and the non-hardened portions not irradiated with the ultraviolet rays. As described above, the alignment treatment on the alignment film may not be necessary if desired light spreading controllability can be obtained without the alignment treatment.

Note that, when the liquid crystal optical element of the embodiments of the present invention is used in a vehicle light, polarizing plates which are typically employed in display apparatus, are not necessary, and the cell gap can be set small as compared to a display device. Furthermore, the liquid crystal optical element can be driven at a lower voltage. Therefore, the transmittance of light is excellent, i.e., 95% or more, and a high speed response in the order of 30 ms can be achieved. Furthermore, the liquid crystal optical element can be driven at a low AC voltage of about 2.5 V. Therefore, the liquid crystal optical element has excellent characteristics as an optical element driven electrically.

In the conventional art, a liquid crystal optical element employed in a vehicle light has served as a shutter for controlling the transmission and interruption of light. The function of the conventional liquid crystal optical element is thus to control the light distribution within the range of a basic light distribution formed from a light source, a reflector, and a lens, and therefore, the light distribution control beyond the range of the basic light distribution can not be achieved.

On the other hand, in the liquid crystal optical element of the embodiments of the present invention, light is controllably shaped into a desired pattern by refraction, whereby the light distribution can be controlled over a wider range beyond the range of the basic light distribution. Therefore, when this liquid crystal optical element is mounted on a vehicle light, the projection range in the horizontal direction can be largely expanded with little change in the projection range in the vertical direction. Thus, a lamp can be realized which does not cause glare to a driver of an oncoming vehicle.

Furthermore, the diffusion degree of light can be continuously adjusted in accordance with the voltage applied to the liquid crystal optical element. Therefore, the projection pattern can also be continuously controlled to generate a desired shape.

Moreover, since the liquid crystal optical element is not operated as a shutter, the projection light is not shielded, and thus the light can be effectively utilized. Therefore, in order to realize an LED light which has recently been under active development for commercialization but has not been realized due to a lack of sufficient brightness, the liquid crystal optical element of the embodiments of the present invention is very effective means as a light distribution control technology utilizing an optical system with low optical loss.

Furthermore, according to the above-described embodiments of the present invention, a light can be designed such that if a voltage is not applied to the liquid crystal optical element for some reasons, the liquid crystal optical element becomes transparent. Therefore, the basic light distribution formed from a light source, a reflector, and a lens can be maintained, and the visibility of a driver is not impeded even in such an abnormal state.

Moreover, since the projecting light can be controlled beyond the basic light distribution pattern formed from the light source, the reflector, and the lens, the projection over a wide range can be achieved even when the light has a small light emission surface to the outside. In addition to this, design flexibility can be increased for a vehicle light as well as a vehicle equipped with the light.

In the exemplary embodiments described above, parallel orientation of liquid crystal molecules is employed, but the present invention is not limited to this orientation form. The liquid crystal optical element has the characteristic that it is transparent when a voltage is not applied, and this characteristic remains in other orientation forms such as vertical molecular orientation and twisted lateral molecular orientation. In particular, when the vertical orientation is employed, since the total projected area of each of the liquid crystal molecules that is exposed to external light decreases, a reduced deterioration due to external light of the liquid crystal is expected. Therefore, the vertical orientation is particularly suited when the liquid crystal optical element is applied to a light employing a discharge lamp which generates a large amount of ultraviolet rays.

Also, liquid crystal having a negative dielectric anisotropy may be employed as the host liquid crystal layer for the photocurable monomer. In that case, various additional or alternative adjustments of the light distribution are possible.

Also, depending on the needs, the direction in which light distribution can be adjustably expanded can be vertical or other direction. Moreover, the pattern of the hardened/non-hardened portions is not limited to equally spaced stripes. Other patterns, such as progressively narrowed stripes, checkerboard patterns, ring patterns, etc., may be employed when such needs arise.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal optical element comprising:
a pair of coupled substrates each having an electrode; and
a liquid crystal layer between the substrates, the liquid crystal layer including an adjustable part and a non-adjustable part, the adjustable part containing liquid crystal having a dielectric anisotropy and being responsive to an electric field that is to be generated by applying a voltage between the electrodes so that orientations of liquid crystal molecules and a resulting refractive index distribution in the adjustable part change in accordance with the electric field, whereas orientations of liquid crystal molecules in the non-adjustable part is substantially fixed so that the non-adjustable part is substantially non-responsive to the electric field.

2. The liquid crystal optical element according to claim 1, further comprising an alignment film in each of the pair of coupled substrates,
wherein the alignment film aligns liquid crystal molecules substantially parallel to a surface on which the alignment film is formed, and
wherein the liquid crystal in the adjustable part has a positive dielectric an isotropy.

3. The liquid crystal optical element according to claim 2, wherein the liquid crystal layer includes a plurality of alternating stripes of the adjustable parts and the non-adjustable parts.

4. The liquid crystal optical element according to claim 3, wherein the alignment film is subjected to a surface treatment which provides uniaxial parallel alignment to the liquid crystal, the surface treatment being performed in a direction which makes a predetermined angle relative to an extending direction of the plurality of alternating stripes.

5. The liquid crystal optical element according to claim 4, wherein the direction of the alignment treatment is set within the range of about ±45° relative to a direction orthogonal to the extending direction of the plurality of the alternating stripes.

6. The liquid crystal optical element according to claim 4, wherein the direction of the alignment treatment is set within the range of about +5° relative to a direction orthogonal to the extending direction of the plurality of the alternating stripes.

7. The liquid crystal optical element according to claim 3, wherein a width of the stripes of the non-adjustable part is within the range of about 10 μm to about 100 μm, and a width of the stripes of the adjustable part is within the range of about 10 μm to about 100 μm.

8. The liquid crystal optical element according to claim 3, wherein a width of the stripes of the non-adjustable part is within the range of about 20 μm to about 50 μm, and a width of the stripes of the adjustable part is within the range of about 20 μm to about 50 μm.

9. The liquid crystal optical element according to claim 1, wherein the non-adjustable part contains a hardened material which is obtained by irradiating a mixed material of liquid crystal and a photocurable monomer with a curing radiation, the mixed material containing the photocurable monomer in an amount of about 1 wt. % to about 15 wt. %, and
wherein the adjustable part contains the mixed material without being subject to irradiation of the curing radiation.

10. The liquid crystal optical element according to claim 9, wherein a refractive index distribution of the adjustable part and that of the non-adjustable part are substantially the same when no voltage is applied to the electrodes, and
wherein the refractive index distribution of the adjustable part changes in accordance with the voltage applied to the electrodes so that an interface of refractive index is generated between the adjustable part and the non-adjustable part.

11. The liquid crystal optical element according to claim 1, further comprising
a voltage application unit connected to the electrodes, for applying a voltage between the electrode to apply an electric filed to the liquid crystal layer.

12. The liquid crystal optical element according to claim 1, wherein the substrates and the electrodes are substantially transparent with respect to visible light.

13. A vehicle light comprising:
a light source;
a reflector located behind the light source; and
a liquid crystal optical element disposed in an optical path of light which is emitted from the light source, the liquid crystal optical element including:
a pair of coupled substrates each having an electrode, and
a liquid crystal layer between the substrates, the liquid crystal layer including an adjustable part and a non-adjustable part, the adjustable part containing liquid crystal having a dielectric anisotropy and being responsive to an electric field that is to be generated by applying a voltage between the electrodes so that orientations of liquid crystal molecules and a resulting refractive index distribution in the adjustable part change in accordance with the electric field, whereas orientations of liquid crystal molecules in the non-adjustable part is substantially fixed so that the non-adjustable part being substantially non-responsive to the electric field.

14. The vehicle light according to claim 13, further comprising:
a voltage application unit connected to the electrodes, for applying a voltage between the electrodes to apply an electric filed to the liquid crystal layer so that a light distribution of light emitted from the vehicle light is controlled.

15. The vehicle light according to claim 13, wherein the light source is a light emitting diode (LED).

16. A method for manufacturing a liquid crystal optical element, comprising:
preparing a pair of substrates each having an electrode and an alignment film;
injecting a mixed material of a liquid crystal material and a photocurable monomer between the pair of the substrates; and
selectively irradiating the mixed material with ultraviolet rays through a photomask to form a pattern of a hardened region and a non-hardened region.

17. The method according to claim 16, wherein ultraviolet-rays irradiation 5 time is within the range of about 10 sec. to about 120 sec.

18. The method according to claim 17, wherein ultraviolet-rays irradiation time is within the range of about 30 sec. to about 120 sec.

19. The method according to claim 16, wherein a refractive index distribution of the liquid crystal material and that of the photocurable monomer are substantially the same.

20. The method according to claim 16, further comprising the step of performing an alignment treatment on each of the alignment film before the step of injecting the mixed material.

21. The method according to claim 20, wherein the step of performing the alignment treatment includes rubbing a surface of the alignment film in a predetermined direction.
